(19) United States
(12) Patent Application Publication
(10) Pub. No.: US 2015/0156480 A1
(43) Pub. Date: Jun. 4, 2015

(54) IMAGE DISPLAY APPARATUS AND METHOD OF DRIVING THE SAME

(71) Applicant: Samsung Display Co., Ltd., Yongin-City (KR)

(72) Inventors: Goro HAMAGISHI, Hwaseong-si (KR); KYUNGHO JUNG, Gyeonggi-do (KR)

(21) Appl. No.: 14/312,574

(22) Filed: Jun. 23, 2014

(30) Foreign Application Priority Data
Dec. 4, 2013 (KR) 10-2013-0150141

(51) Int. Cl. H04N 13/04; G09G 3/36; G09G 3/34

(52) U.S. Cl. CPC H04N 13/0402; G09G 3/3406; G09G 3/36; H04N 13/0468

(57) ABSTRACT

An image display apparatus includes a display unit configured to display an image, a viewpoint generating unit, and a directional backlight unit. The viewpoint generating unit is configured to operate in a 2D mode or a 3D mode so as to render the image as a 2D image or a 3D image, and to generate N viewpoints in different directions while operating in the 3D mode. The directional backlight unit is configured to supply light to an illumination area of an image plane, wherein the image plane is placed at a visible distance to a plurality of observers and the image from the display unit is projected onto the image plane, and wherein positions of the illumination area and a non-illumination area of the image plane are changed based on positional information of the plurality of observers.

### CROSS-REFERENCE TO RELATED APPLICATION

This U.S. non-provisional patent application claims priority under 35 U.S.C. §119 to Korean Patent Application No. 10-2013-0150141 filed on Dec. 4, 2013, the contents of which are hereby incorporated by reference in its entirety.

### BACKGROUND

1. Field of Disclosure

The present disclosure relates to an image display apparatus and a method of driving the same. More particularly, the present disclosure relates to an image display apparatus capable of displaying a three-dimensional image and a method of driving the image display apparatus.

2. Description of the Related Art

A three-dimensional image display apparatus, that is based on auto-stereoscopic display technology, is capable of displaying a three-dimensional image without a shutter glasses. Parallax barrier schemes and lenticular lens schemes are widely used in auto-stereoscopic display technology.

A three-dimensional image display apparatus employing a parallax barrier scheme typically include a parallax barrier (through which vertical lattice-shape openings are formed) disposed in front of a display panel. The display panel typically includes pixels arranged in rows by columns. The parallax barrier separates a right-eye image and a left-eye image with respect to the right and left eyes of an observer, so as to generate a binocular disparity in different images.

A three-dimensional image display apparatus employing the lenticular lens scheme typically includes a lenticular lens sheet (having a plurality of semi-cylindrical lenses arranged in a column direction) disposed on the display panel.

### SUMMARY

The present disclosure provides an image display apparatus capable of displaying a three-dimensional image that is recognizable by observers even when the observers are moving from one place to another.

According to some embodiments of the inventive concept, an image display apparatus is provided. The image display apparatus includes a display unit configured to display an image; a viewpoint generating unit configured to operate in a 2D mode or a 3D mode so as to render the image as a 2D image or a 3D image, and to generate N viewpoints in different directions while operating in the 3D mode; and a directional backlight unit configured to supply light to an illumination area of an image plane, wherein the image plane is placed at a visible distance to a plurality of observers and the image from the display unit is projected onto the image plane, and wherein positions of the illumination area and a non-illumination area of the image plane are changed based on positional information of the plurality of observers.

In some embodiments, images of the N viewpoints may be displayed in a plurality of view sets disposed on the image plane, and wherein the illumination area may have a width equal to or greater than a width of each of the view sets.

In some embodiments, each of the view sets may include N viewing zones, each of the illumination area and the non-illumination area may include a plurality of control areas, and each of the control areas may have a width equal to or greater than a width of the viewing zones.

In some embodiments, the width of each of the control areas may correspond to two times the width of the viewing zones.

In some embodiments, the width of each of the viewing zones may correspond to a distance between both eyes of each observer.

In some embodiments, the directional backlight unit may further include a backlight configured to generate the light; a light emitting area control unit disposed between the display unit and the backlight, wherein the light emitting area control unit includes a slit part to transmit the light and a barrier part to block the light when the viewpoint generating unit is operating in the 3D mode, and wherein positions of the slit part and the barrier part may be changed in accordance with the positional information of the observers; and a directional control unit configured to guide the light being transmitted through the slit part to the illumination area.

In some embodiments, the light emitting area control unit may further include a first substrate including a reference electrode; a second substrate facing the first substrate and including a plurality of control electrodes disposed in a unit area; and a liquid crystal layer interposed between the first substrate and the second substrate, and wherein the position and width of the illumination area may be changed in accordance with a position and number of the control electrodes that are applied with a driving voltage.

In some embodiments, when “m” number of the control electrodes are disposed in the unit area and each of the illumination area and the non-illumination area includes a plurality of control areas, a width of a visible range may be obtained by multiplying a width of each of the control areas by “m”.

In some embodiments, the display unit may be configured to drive one frame in a time division mode after dividing the one frame into at least two sub-frames, and the light emitting area control unit may be driven such that the positions of the illumination area and the non-illumination area are changed in a unit of the sub-frame.

In some embodiments, the directional control unit may include a lens film including a plurality of lenticular lenses.

In some embodiments, each of the lenticular lenses may have a width corresponding to the unit area.

In some embodiments, the image display apparatus may further include a position information extracting unit configured to extract the positional information of the observers; and a control unit configured to control a drive of the directional backlight unit in accordance with the positional information.

In some embodiments, the image plane may include a first area that allows the observers to recognize the 3D image and a second area that does not allow the observers to recognize the 3D image, and positions of the first and second areas may be changed by the time division drive of the display unit and the viewpoint generating unit.

In some embodiments, the control unit may be configured to check whether each of the observers is placed in the first area or in the second area in accordance with the positional information, and to drive the directional backlight unit in the time division mode in synchronization with the display unit to control the position of the illumination area such that the observer placed in the first area receives the light in each sub-frame.

In some embodiments, the viewpoint generating unit may include a liquid crystal barrier panel in which a transmission area transmitting the light and a blocking area blocking the light are alternately arranged with each other in a first direction so as to connect the left and right eyes of the observer.

In some embodiments, the viewpoint generating unit may include a liquid crystal lens panel arranged in a first direction so as to connect the left and right eyes of the observer, and wherein the viewpoint generating unit may extend in a second direction substantially perpendicular to the first direction.

According to some other embodiments of the inventive concept, a method of driving an image display apparatus is provided. The method includes forming N viewpoints in different directions when a display unit, which is configured to operate in a 2D mode or a 3D mode so as to render an image displayed on the display unit as a 2D image or a 3D image, is being operated in the 3D mode; extracting positional information of a plurality of observers with reference to the display unit; dividing an image plane placed at a visible distance to the plurality of observers into a first area that allows the observers to recognize the 3D image and a second area that does not allow the observers to recognize the 3D image, wherein the image from the display unit is projected onto the image plane; changing positions of the first and second areas through a time division drive; and controlling, in accordance with the position information, an illumination area and a non-illumination area formed on the image plane.

In some embodiments of the method, images of the N viewpoints may be displayed in a plurality of view sets disposed on the image plane, and the illumination area may have a width equal to or greater than a width of each of the view sets.

In some embodiments of the method, each of the view sets may include N viewing zones, each of the illumination area and the non-illumination area may include a plurality of control areas, and each of the control areas may have a width equal to or greater than a width of the viewing zones.

In some embodiments of the method, the width of each of the control areas may correspond to two times the width of the viewing zones, and the width of each of the viewing zones may correspond to a distance between both eyes of each observer.

### BRIEF DESCRIPTION OF THE DRAWINGS

The above and other advantages of the present disclosure will be readily apparent with reference to the following detailed description in conjunction with the accompanying drawings.

FIG. 1 is a block diagram showing a three-dimensional image display apparatus according to an exemplary embodiment of the present disclosure.

FIG. 2A is a view showing an illumination area and a non-illumination area, as illuminated by a directional backlight unit during a first sub-frame.

FIG. 2B is a view showing an illumination area and a non-illumination area, as illuminated by a directional backlight unit during a second sub-frame.

FIGS. 3A and 3B are views describing a method of providing a three-dimensional image to two observers.

FIGS. 4A and 4B are views describing a method of providing a three-dimensional image to three observers.

FIGS. 5A and 5B are views describing a method of providing a three-dimensional image to four observers.

FIGS. 6A and 6B are views showing a movement of an illumination area when an observer moves.

FIGS. 7A and 7B are views describing a method of providing a three-dimensional image when a first observer and a second observer are simultaneously placed in a first area or a second area.

FIGS. 8A and 8B are views describing a method of providing a three-dimensional image when a first observer and a second observer are placed respectively in a first area and a second areas.

FIG. 9 is a view showing a visible range of a three-dimensional image display apparatus.

FIG. 10 is a partially enlarged view showing the portion “I” in FIG. 9.

FIG. 11 is a cross-sectional view showing a three-dimensional image display apparatus according to another exemplary embodiment of the present disclosure.

FIG. 12 is a view showing a visible range of the three-dimensional image display apparatus in FIG. 11.

FIG. 13 is a partially enlarged view showing the portion “II” in FIG. 12.

### DETAILED DESCRIPTION

It will be understood that when an element or layer is referred to as being “on”, “connected to” or “coupled to” another element or layer, it can be directly on, connected or coupled to the other element or layer, or with one or more intervening elements or layers being present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, the elements, components, regions, layers and/or sections should not be limited by those terms. Those terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath”, “below”, “lower”, “above”, “upper” and the like, may be used herein for ease of description to describe one element or feature's spatial relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended limit the inventive concept. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

The inventive concept will be described in detail herein with reference to the accompanying drawings.

A three-dimensional (3D) image display apparatus may include a stereoscopic display apparatus. The stereoscopic display apparatus provides the left and right eyes of an observer with respective left-eye and right-eye images, regardless of the observer's position with reference to the 3D image display apparatus. An image is displayed on the 3D image display apparatus by summing the left-eye and right-eye images in all directions, and separating the left-eye and right-eye images from each other using a shutter glass.

An auto-stereoscopic display apparatus provides the same visual effects as a stereoscopic display apparatus when only one observer is located at a fixed position. Unlike the stereoscopic display apparatus, the auto-stereoscopic display apparatus provides the left-eye and right-eye images to the left and right eyes of the observer after separating the left-eye and right-eye images. As a result, when more than one observer are positioned with reference to the 3D image display apparatus and the observers are moving, the left-eye and right-eye images may not be artificially separated. Accordingly, a multi-view auto-stereoscopic display apparatus may display a plurality of viewpoint images by combining the left-eye and right-eye images.

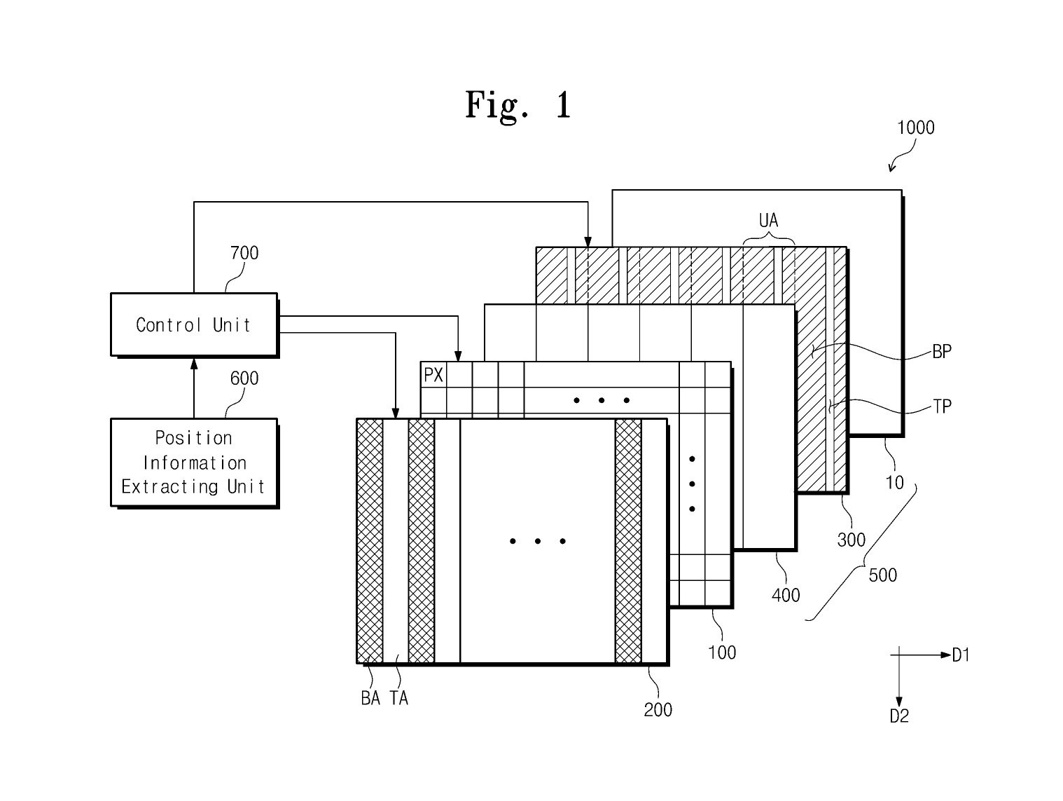

FIG. 1 is a block diagram showing a 3D image display apparatus 1000 employing a multi-view auto-stereoscopic system according to an exemplary embodiment of the present disclosure. As described above, the multi-view auto-stereoscopic system is capable of generating a plurality of viewpoint images on a screen.

Referring to FIG. 1, the 3D image display apparatus 1000 includes a display unit 100, a viewpoint generating unit 200, a directional backlight unit 500, a position information extracting unit 600, and a control unit 700.

The display unit 100 includes a plurality of pixels PX. The pixels PX are arranged in a first direction D1 and in a second direction D2 substantially perpendicular to the first direction D1 (i.e., the pixels PX are arranged in a matrix form). Each of the pixels PX includes first, second, and third sub-pixels having red, green, and blue color pixels, respectively. Nevertheless, it should be noted that the number of sub-pixels and the color of the sub-pixels are not limited to the above, and may also include other different colors and configurations.

The viewpoint generating unit 200 is disposed above the display unit 100. The viewpoint generating unit 200 includes a liquid crystal barrier panel. The liquid crystal barrier panel controls transmission of light through the application of a driving voltage to the liquid crystal barrier. When the liquid crystal barrier panel includes normally-white liquid crystals, an area to which no voltage is applied is referred to as a transmission area TA, and an area to which the driving voltage is applied is referred to as a blocking area BA.

The 3D image display apparatus 1000 may operate in a two-dimensional (2D) mode or a 3D mode. The liquid crystal barrier panel is turned off during the 2D mode so as to transmit a 2D image provided from the display unit 100, and turned on during the 3D mode so as to convert the 2D image from the display unit 100 to a 3D image.

As shown in FIG. 1, the blocking area BA and the transmission area TA are alternately arranged in the first direction D1. As an example, each of the blocking area BA and the transmission area TA is shown extending in the second direction D2.

When the 3D image display apparatus 1000 is driven at about 120 Hz, a frame may be divided into two sub-frames. The liquid crystal barrier panel may be driven such that the positions of the blocking area BA and the transmission area TA are changed with respect to each other in one sub-frame. In this case, the display unit 100 may be driven in a time division mode so as to display two different sets of frame images in one sub-frame. That is, the liquid crystal barrier panel may selectively open or close a specific area in synchronization with the display unit 100.

When the 3D image display apparatus 1000 is in the 3D mode, an angle at which light (that forms the image) exits from the display unit 100 may be limited by the transmission area TA and the blocking area BA. In particular, the light from N pixels disposed corresponding to the transmission area TA is converted to N viewpoint images after passing through the transmission area TA. Accordingly, binocular parallax occurs between the respective images provided to the left and right eyes of an observer, thereby allowing the observer to recognize the 3D image.

The directional backlight unit 500 further includes a backlight 10, a light emitting area control unit 300, and a directional control unit 400.

The backlight 10 includes a light source for emitting light to the display unit 100. A point light source or a linear light source may be used as the light source. In the present exemplary embodiment, the backlight 10 may include a plurality of light emitting diodes.

The light emitting area control unit 300 is interposed between the backlight 10 and the display unit 100. The light emitting area control unit 300 includes a transparent slit part TP to transmit the light from the backlight 10 and a barrier part BP to block the light from the backlight 10. The transparent slit part TP and the barrier part BP are alternately arranged with each other in the first direction D1. As an example, each of the transparent slit part TP and the barrier part BP is shown extending in the second direction D2. The light emitting area control unit 300 may be divided into a plurality of unit areas UA, with each unit area UA including a transparent slit part TP and a barrier part BP.

Although not shown in the figures, the light emitting area control unit 300 may include a liquid crystal panel including two substrates and a liquid crystal layer disposed between the two substrates, a first polarizing plate, and a second polarizing plate facing the first polarizing plate with the liquid crystal panel disposed between the first and second polarizing plates. The liquid crystal layer may include twisted-nematic liquid crystals arranged in a twisted state at about 90 degrees in the absence of an electric field. The first polarizing plate has a polarizing axis that is substantially perpendicular to a polarizing axis of the second polarizing plate. The liquid crystal panel may include a plurality of control electrodes (not shown) in each unit area UA. An area in which the driving voltage is not applied to the control electrodes is referred to as the transparent slit part TP. The transparent slit part TP transmits the light since the twisted state of the liquid crystals is maintained. An area in which the driving voltage is applied to the control electrodes is referred to as the barrier part BP. The barrier part BP blocks the light since the twisted state of the liquid crystals is untied.

The directional control unit 400 is interposed between the light emitting area control unit 300 and the display unit 100. The directional control unit 400 includes a film having a lenticular lens. The lenticular lens has a semi-cylindrical shape extending in the second direction D2. A plurality of lenticular lens may be provided and arranged in the first direction D1. Each of the lenticular lenses has a pitch corresponding to a width of the unit area UA.

The position information extracting unit 600 is configured to extract positional information of the observer with reference to the display unit 100. The position information extracting unit 600 extracts vertical distance information between the display unit 100 and the observer, and also horizontal movement information of the observer in a direction substantially parallel to the display unit 100.

In particular, when several observers are positioned with reference to the display unit 100, the position information extracting unit 600 extracts the positional information of each observer and sends the extracted positional information to the control unit 700.

The control unit 700 is configured to control the display unit 100, the liquid crystal barrier panel, and the directional backlight unit 500. When the 3D image display apparatus 1000 is driven in the 2D mode, the control unit 700 turns off the liquid crystal barrier panel 200. Conversely, when the 3D image display apparatus 1000 is driven in the 3D mode, the control unit 700 turns on the liquid crystal barrier panel 200.

When the 3D image display apparatus 1000 is driven in the 3D mode, the control unit 700 may drive the display unit 100 in the time division mode at a frequency (e.g., 120 Hz) that is two times higher than that of the 2D mode and operate the liquid crystal barrier panel in synchronization with the time-division drive of the display unit 100.

In addition, the control unit 700 may control an illumination area and a non-illumination area of the directional backlight unit 500 in accordance with the positional information of the observers.

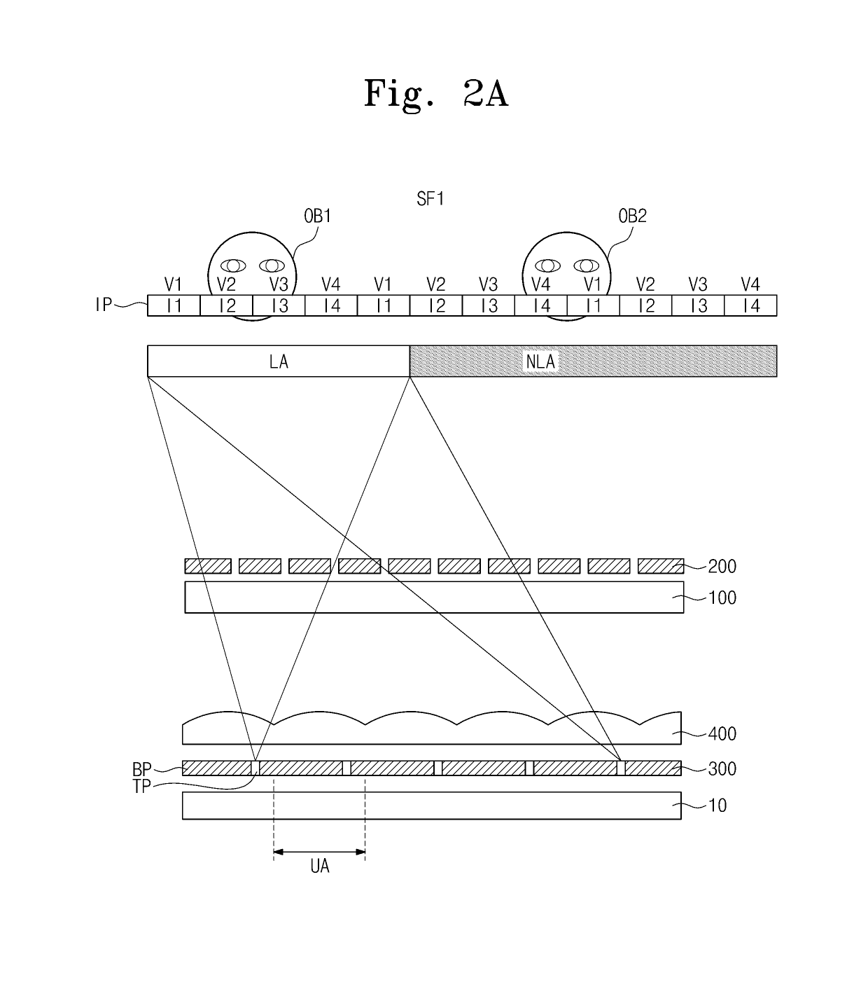

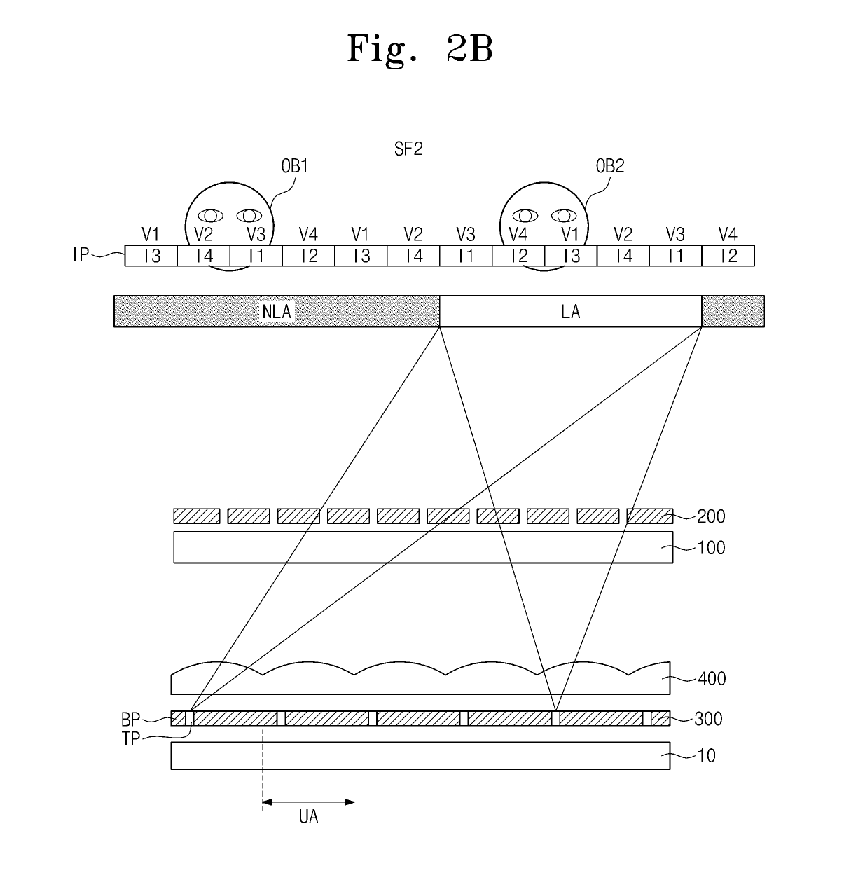

FIG. 2A is a view showing the illumination area and the non-illumination area, as illuminated by the directional backlight unit 500 during a first sub-frame. FIG. 2B is a view showing the illumination area and the non-illumination area, as illuminated by the directional backlight unit 500 during a second sub-frame.

Referring to FIG. 2A, the light (that forms the image) exiting from the display unit 100 is projected onto an image plane IP placed at a visible distance to the observer. The image plane IP includes an illumination area LA and a non-illumination area NLA. The directional backlight unit 500 supplies the light to the illumination area LA of the image plane IP, and does not supply the light to the non-illumination area NLA of the image plane IP.

In some embodiments, the 3D image display apparatus 1000 may include a four-view display apparatus that provides four views on the image plane IP. In those embodiments, first, second, third, and fourth viewing zones V1, V2, V3, and V4 are sequentially and repeatedly arranged in the first direction D1 (refer to FIG. 1) on the image plane IP. An image I1 (herein referred to as a first image) of a first pixel is displayed in the first viewing zone V1, and an image I2 (herein referred to as a second image) of a second pixel is displayed in the second viewing zone V2. An image I3 (herein referred to as a third image) of a third pixel is displayed in the third viewing zone V3, and an image 14 (herein referred to as a fourth image) of a fourth pixel is displayed in the fourth viewing zone V4.

Referring to FIG. 2A, when an observer OB is located at a first position (e.g., where a first observer OB1 is located), the left and right eyes of the observer OB respectively see the second image I2 displayed in the second viewing zone V2 and the third image I3 displayed in the third viewing zone V3. The observer OB may then recognize the 3D image due to the binocular disparity between his/her left and right eyes. Accordingly, the observer OB may recognize the 3D image in the first to fourth viewing zones V1 to V4.

However, when the observer OB is located at a second position (e.g., where a second observer OB2 is located), the view sets may change such that the left and right eyes of the observer OB respectively see the fourth image I4 displayed in the fourth viewing zone V4 and the first image I1 displayed in the first viewing zone V1. Accordingly, the observer OB may not be able to recognize the 3D image due to crosstalk between the fourth image I4 and the first image I1.

When the number of viewpoints increases, the number of positions (at which the 3D image is recognized) are increased. However, a resolution of the 3D image display apparatus 1000 is reduced in inverse proportion to the number of viewpoints.

To prevent the resolution of the 3D image display apparatus 1000 from being reduced, the image at about 60 Hz is alternately displayed every i-th frame and the position of the transmission area TA of the liquid crystal barrier 200 is shifted by 1/i pitch in synchronization with the image at about 60 Hz. Accordingly, a 3D image having the same resolution as that of the 2D image may be realized.

In the embodiments of FIGS. 2A and 2B, one frame is divided into two sub-frames (i.e., first and second sub-frames SF1 and SF2), and driven at a frequency of about 120 Hz.

In addition, when two or more observers are placed at different positions, the position information extracting unit 600 (refer to FIG. 1) extracts the positional information of each observer and the control unit 700 controls the directional backlight unit 500, so as to allow the observers to recognize the 3D image in the sub-frames in accordance with the extracted positional information.

As an example, the 3D image display apparatus 1000 may be operated to allow the first observer OB1 to recognize the 3D image during the first sub-frame SF1 and to allow the second observer OB2 to recognize the 3D image during the second sub-frame SF2.

As shown in FIG. 2A, the position of the transparent slit part TP in each unit area UA of the light emitting area control unit 300 is biased to a right side with respect to a center line in each unit area UA during the first sub-frame SF1. In this case, the direction in which the light emitted from the backlight 10 travels is biased toward a left direction after passing through the lens of the directional control unit 400. Thus, the illumination area LA is placed at the position corresponding to the first observer OB1, and the first observer OB1 may recognize the image projected on the image plane IP as the 3D image. Meanwhile, since the second observer OB2 is placed at the position corresponding to the non-illumination area NLA to which the light is not supplied, the second observer OB2 may not be able to recognize the image.

As shown in FIG. 2B, the position of the transparent slit part TP in each unit area UA of the light emitting area control unit 300 is biased to a left side with respect to the center line in each unit area UA during the second sub-frame SF2. In this case, the direction in which the light emitted from the backlight 10 travels is biased toward a right direction after passing through the lens of the directional control unit 400. Accordingly, the illumination area LA is placed at the position corresponding to the second observer OB2, and the second observer OB2 may recognize the image projected on the image plane IP as the 3D image. Meanwhile, since the first observer OB1 is placed at the position corresponding to the non-illumination area NLA to which the light is not supplied, the first observer OB1 may not be able to recognize the image.

The image projected onto the image plane IP may change in position. For instance, when the first to fourth images I1 to I4 are respectively displayed in the first to fourth viewing zones V1 to V4 of the image plane IP during the first sub-frame SF1, the first and second images I1 and I2 are respectively displayed in the third and fourth viewing zones V3 and V4 during the second sub-frame SF2, and the third and fourth images I3 and I4 are respectively displayed in the first and second viewing zones V1 and V2 during the second sub-frame SF2.

The image displayed in the first to fourth viewing zones V1 to V4 is shifted by two pixels at every sub-frame SF1 and SF2. However, the inventive concept is not limited thereto. For example, in some embodiments, the image displayed in the first to fourth viewing zones V1 to V4 may be shifted by more than two pixels at every sub-frame SF1 and SF2. In addition, the image displayed in the first to fourth viewing zones V1 to V4 may be changed by changing the image information displayed in the pixels of the display unit 100 or by controlling the positions of the blocking area BA and the transmission area TA of the liquid crystal barrier panel 200.

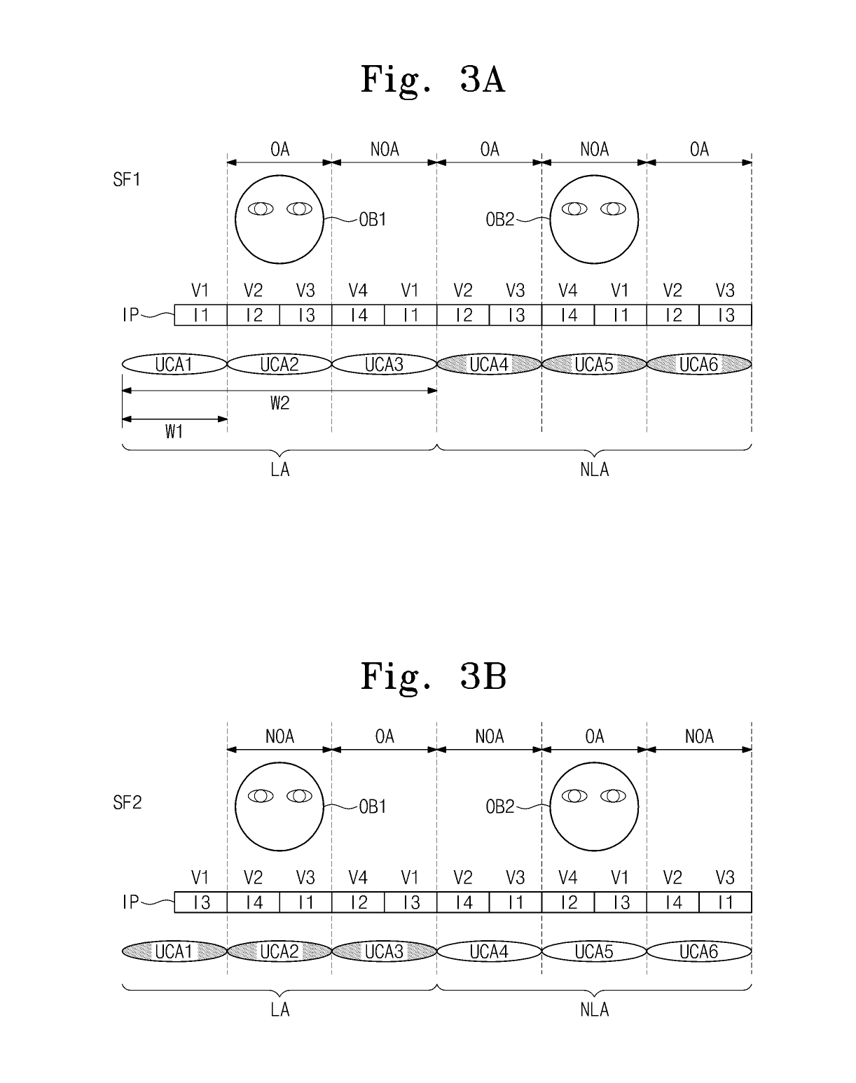

FIGS. 3A and 3B are views describing a method of providing a three-dimensional image to two observers. FIG. 3A shows the first observer OB1 recognizing the 3D image during the first sub-frame SF1 of one frame, and FIG. 3B shows the second observer OB2 recognizing the 3D image during the second sub-frame SF2 of one frame.

Referring to FIG. 3A, the image plane IP on which light (that forms the image) exiting from the display unit 100 is projected includes a first area OA (which allows the observer to recognize the 3D image) and a second area NOA (which does not allow the observer to recognize the 3D image).

As an example, each of the first and second areas OA and NOA may have a width that is two times greater than a width of each of the first to fourth viewing zones V1 to V4, and the first and second areas OA and NOA may be alternately arranged in the first direction D1 (refer to FIG. 1).

In addition, the image plane IP includes the illumination area LA and the non-illumination area NLA. The image plane IP further includes first to sixth control areas UCA1 to UCA6 that are controlled by the unit area UA (refer to FIGS. 2A and 2B) of the light emitting area control unit 300. The number of control areas UCA1 to UCA6 may be changed depending on the visible range of the 3D image display apparatus. In the interest of clarity, only six control areas are depicted in FIGS. 3A and 3B. Each of the control areas UCA1 to UCA6 has a width that is two times greater than a width of each of the first to fourth viewing zones V1 to V4. In some embodiments, when the width of each of the first to fourth viewing zones V1 to V4 is set as a distance between both eyes of each observer (e.g., about 65 mm), the width W1 of each of the control areas UCA1 to UCA6 may be about 130 mm.

The position information extracting unit 600 (refer to FIG. 1) checks whether the position of each of the first and second observers OB1 and OB2 is in the first area OA or in the second area NOA. In the present exemplary embodiment, the first and second observers OB1 and OB2 are placed in the first and second areas OA and NOA, respectively. The position information extracting unit 600 extracts the position of each of the first and second observers OB1 and OB2 by checking whether a center portion of both eyes of each of the first and second observers OB1 and OB2 is in the first area OA or in the second area NOA.

When the first observer OB1 is placed in the first area OA, the directional backlight unit 500 supplies the light to the area in which the first observer OB1 is placed, such that the first observer OB1 recognizes the 3D image. In particular, the directional backlight unit 500 is controlled to supply the light to the first to third control areas UCA1 to UCA3. Therefore, the first to third control areas UCA1 to UCA3 are set to the illumination area LA during the first sub-frame SF1, and the fourth to sixth control areas UCA4 to UCA6 are set to the non-illumination area NLA during the second sub-frame SF2.

The illumination area LA has a width W2 that is wide enough to cover the first to fourth viewing zones V1 to V4. That is, the width W2 of the illumination area LA is equal to or greater than a sum of the widths of the first to fourth viewing zones V1 to V4. As an example, the illumination area LA may have a width W2 that is three times greater than a width of each of the control areas UCA1 to UCA6.

Meanwhile, since the second observer OB2 is placed in the second area NOA, the directional backlight unit 500 does not supply the light to the area in which the second observer OB2 is placed, and thus the second observer OB2 may not be able to recognize the 3D image.

Referring to FIG. 3B, the image displayed in the first to fourth viewing zones V1 to V4 is changed in the second sub-frame SF2, and the positions of the first and second areas OA and NOA are changed with respect to each other when compared to those in the first sub-frame SF1. Accordingly, the first observer OB1 is placed in the second area NOA and the second observer OB2 is placed in the first area OA.

The directional backlight unit 500 supplies the light to the area in which the second observer OB2 is placed, such that the second observer OB2 recognizes the 3D image. In particular, the directional backlight unit 500 is controlled to supply the light to the fourth to sixth control areas UCA4 to UCA6. Therefore, the fourth to sixth control areas UCA4 to UCA6 are set to the illumination area LA during the second sub-frame SF2.

Meanwhile, the first observer OB1 is placed in the second area NOA. Therefore, the directional backlight unit 500 sets the first to third control areas UCA1 to UCA3, in which the first observer OB1 is placed, to the non-illumination area NLA, and thus the first observer OB1 may not be able to recognize the 3D image.

As described above, although the observers are placed at different positions from each other, the light supplied to the observers is controlled after the position of each observer is extracted and checked to ensure that the extracted position of each observer allows each observer to recognize the 3D image. Accordingly, the light is supplied to the observer placed in the first area OA in each sub-frame, and therefore each observer may recognize the 3D image while moving from one place to another.

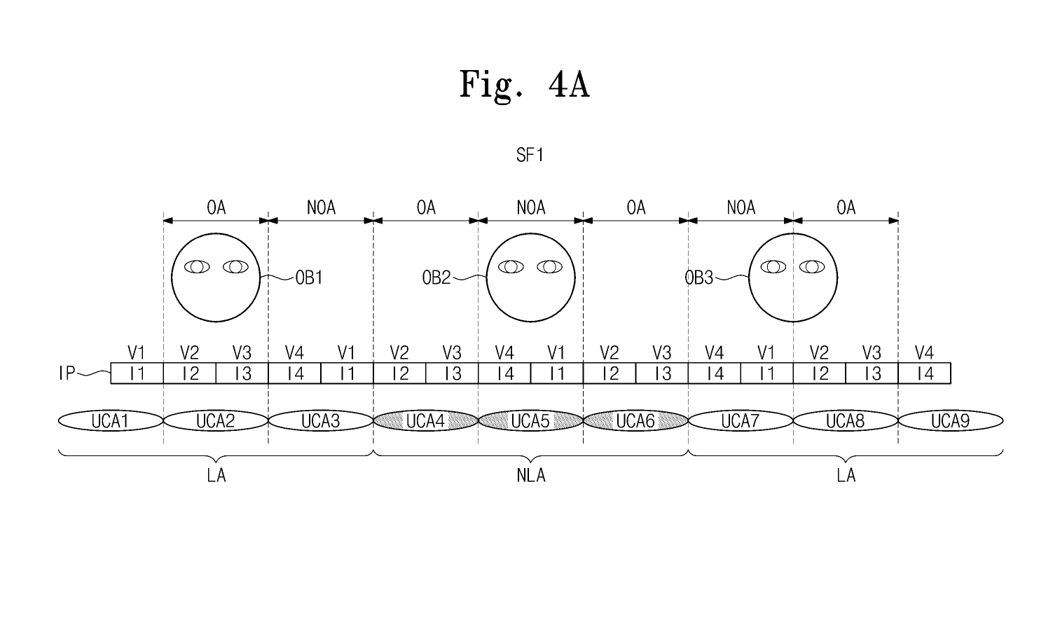

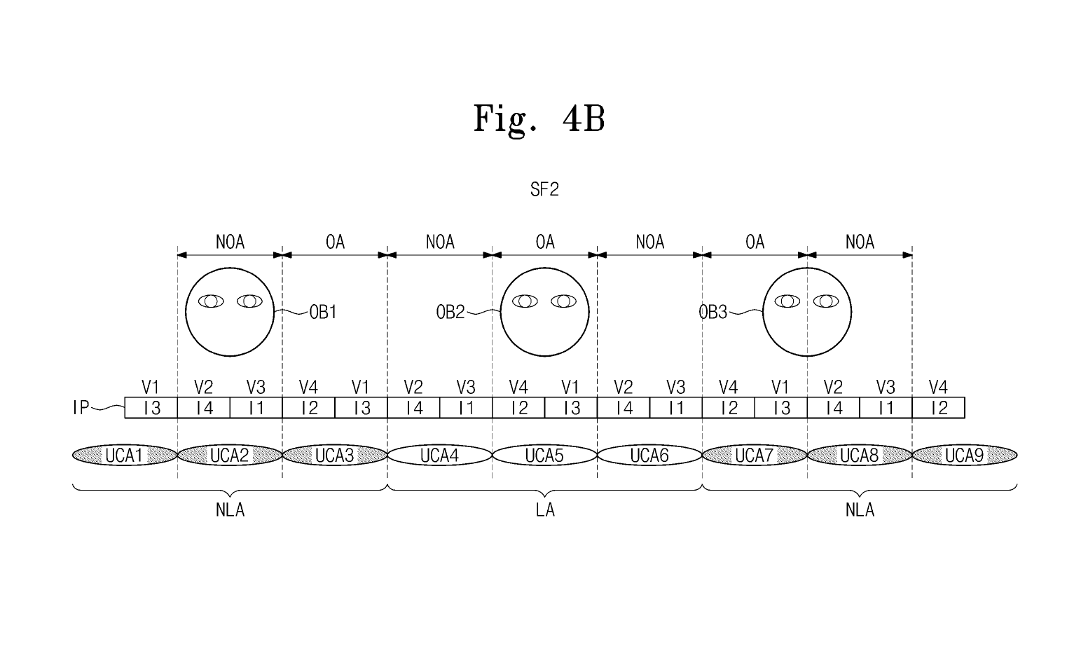

FIGS. 4A and 4B are views describing a method of providing a three-dimensional image to three observers. FIG. 4A shows first and third observers OB1 and OB3 recognizing the 3D image during the first sub-frame of one frame. FIG. 4B shows the second observer OB2 recognizing the 3D image during the second sub-frame of one frame.

Referring to FIG. 4A, the image plane IP includes the illumination area LA and the non-illumination area NLA. The image plane IP includes first to ninth control areas UCA1 to UCA9 that are controlled by the unit area UA (refer to FIGS. 2A and 2B) of the light emitting control unit 300.

When the first and third observers OB1 and OB3 are placed in the first area OA during the first sub-frame SF1, the directional backlight unit 500 supplies the light to the area in which the first and third observers OB1 and OB3 are placed, such that the first and third observers OB1 and OB3 recognize the 3D image. In particular, the directional backlight unit 500 is controlled to supply the light to the first to third control areas UCA1 to UCA3 and the seventh to ninth control areas UCA7 to UCA9. Therefore, the first to third control areas UCA1 to UCA3 and the seventh to ninth control areas UCA7 to UCA9 are set to the illumination area LA during the first sub-frame SF1.

Meanwhile, the second observer OB2 is placed in the second area NOA. Therefore, the directional backlight unit 500 sets the fourth to sixth control areas UCA4 to UCA6, in which the second observer OB2 is placed, to the non-illumination area NLA, and thus the second observer OB2 may not be able to recognize the 3D image.

Referring to FIG. 4B, the image displayed in the first to fourth viewing zones V1 to V4 is changed in the second sub-frame SF2, and the positions of the first and second areas OA and NOA are changed with respect to each other when compared to those in the first sub-frame SF1. Accordingly, the first and third observers OB1 and OB3 are placed in the second area NOA and the second observer OB2 is placed in the first area OA.

The directional backlight unit 500 supplies the light to the area in which the second observer OB2 is placed, such that the second observer OB2 recognizes the 3D image. In particular, the directional backlight unit 500 is controlled to supply the light to the fourth to sixth control areas UCA4 to UCA6. Therefore, the fourth to sixth control areas UCA4 to UCA6 are set to the illumination area LA during the second sub-frame SF2.

Meanwhile, the first and third observers OB1 and OB3 are placed in the second area NOA. Therefore, the directional backlight unit 500 sets the first to third control areas UCA1 to UCA3 and the seventh to ninth control areas UCA7 to UCA9, in which the first and third observers OB1 and OB3 are placed, to the non-illumination area NLA, and thus the first and third observers OB1 and OB3 may not be able to recognize the 3D image.

As described above, although the observers are placed at different positions from each other, the light supplied to the observers is controlled after the position of each observer is extracted and checked to ensure that the extracted position of each observer allows each observer to recognize the 3D image. Accordingly, the light is supplied to the observer(s) placed in the first area OA in each sub-frame, and therefore the observer(s) may recognize the 3D image while moving from one place to another.

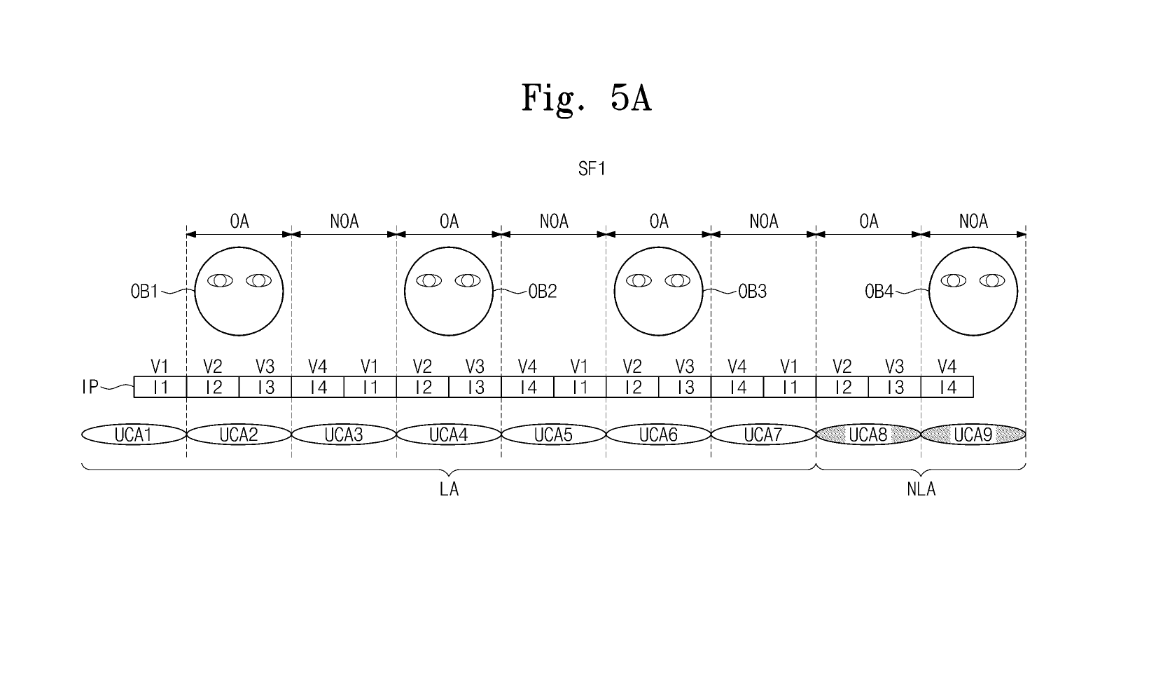

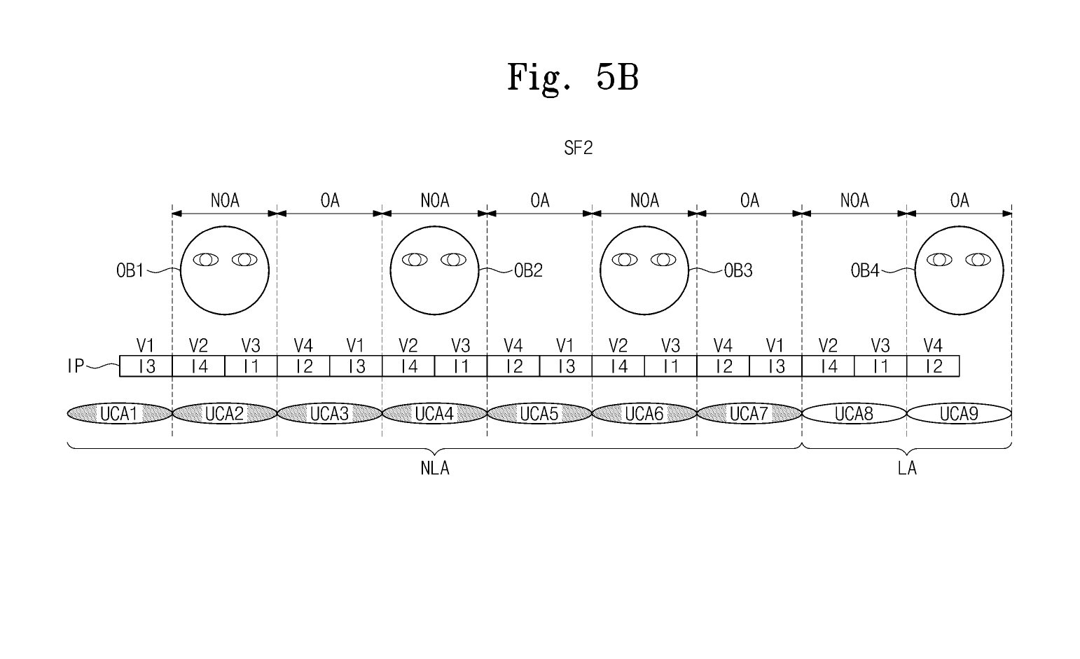

FIGS. 5A and 5B are views describing a method of providing a three-dimensional image to four observers. FIG. 5A shows first, second, and third observers OB1, OB2, and OB3 recognizing the 3D image during the first sub-frame of one frame. FIG. 5B shows the fourth observer OB4 recognizing the 3D image during the second sub-frame of one frame.

Referring to FIG. 5A, the image plane IP includes the illumination area LA and the non-illumination area NLA. The image plane IP includes first to ninth control areas UCA1 to UCA9 that are controlled by the unit area UA (refer to FIGS. 2A and 2B) of the light emitting control unit 300.

When the first, second, and third observers OB1, OB2, and OB3 are placed in the first area OA during the first sub-frame SF1, the directional backlight unit 500 supplies the light to the area in which the first, second, and third observers OB1, OB2, and OB3 are placed, such that the first, second, and third observers OB1, OB2, and OB3 recognize the 3D image. In particular, the directional backlight unit 500 is controlled to supply the light to the first to seventh control areas UCA1 to UCA7. Therefore, the first to seventh control areas UCA1 to UCA7 are set to the illumination area LA during the first sub-frame SF1.

Meanwhile, the fourth observer OB4 is placed in the second area NOA. Therefore, the directional backlight unit 500 sets the eighth and ninth control areas UCA8 and UCA9, in which the fourth observer OB4 is placed, to the non-illumination area NLA, and thus the fourth observer OB4 may not be able to recognize the 3D image.

Referring to FIG. 5B, the image displayed in the first to fourth viewing zones V1 to V4 is changed in the second sub-frame SF2, and the positions of the first and second areas OA and NOA are changed with respect to each other when compared to those in the first sub-frame SF1. Accordingly, the first, second, and third observers OB1, OB2, and OB3 are placed in the second area NOA and the fourth observer OB4 is placed in the first area OA.

The directional backlight unit 500 supplies the light to the area in which the fourth observer OB4 is placed, such that the fourth observer OB4 recognizes the 3D image. In particular, the directional backlight unit 500 is controlled to supply the light to the eighth and ninth control areas UCA8 and UCA9. Therefore, the eighth and ninth control areas UCA8 and UCA9 are set to the illumination area LA during the second sub-frame SF2.

Meanwhile, the first, second, and third observers OB1, OB2, and OB3 are placed in the second area NOA. Therefore, the directional backlight unit 500 sets the first to seventh control areas UCA1 to UCA7, in which the first, second, and third observers OB1, OB2, and OB3 are placed, to the non-illumination area NLA, and thus the first, second, and third observers OB1, OB2, and OB3 may not be able to recognize the 3D image.

As described above, although the observers are placed at different positions from each other, the light supplied to the observers is controlled after the position of each observer is extracted and checked to ensure that the extracted position of each observer allows each observer to recognize the 3D image. Accordingly, the light is supplied to the observer(s) placed in the first area OA in each sub-frame, and therefore the observer(s) may recognize the 3D image while moving from one place to another.

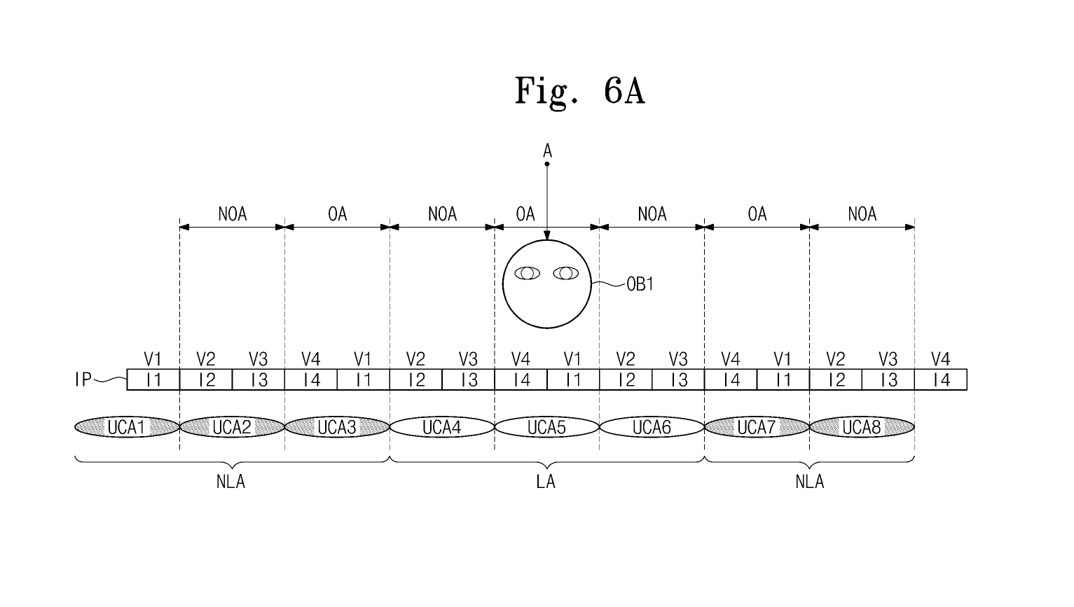

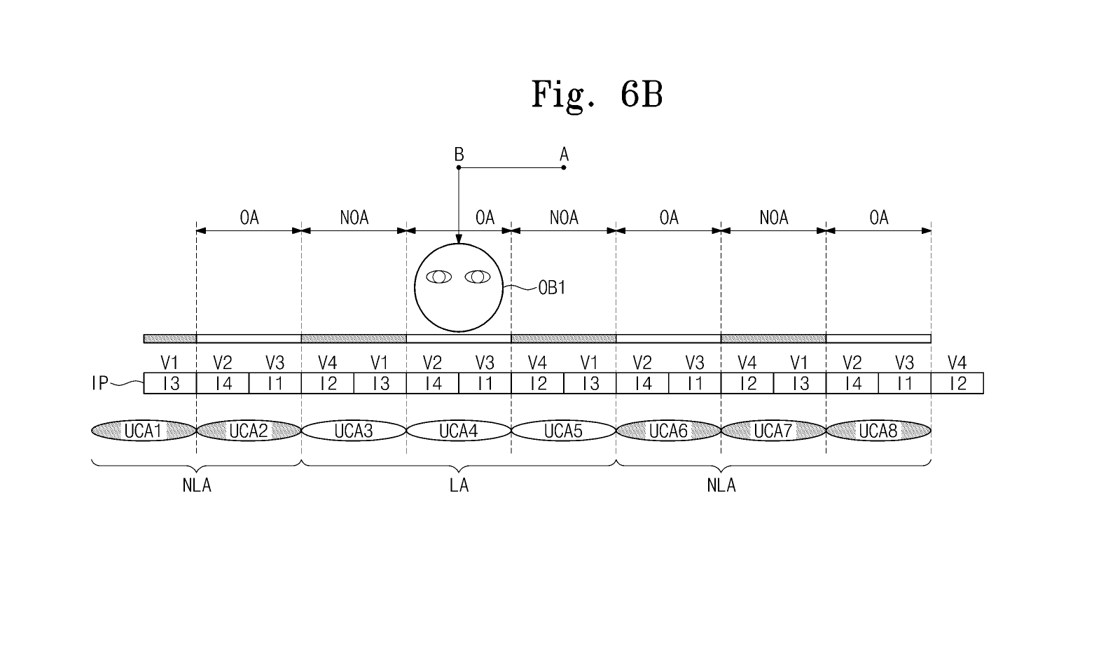

FIGS. 6A and 6B are views showing a movement of an illumination area when the observer moves. FIG. 6A shows the observer recognizing the 3D image at a position “A” during the first sub-frame of one frame. FIG. 6B shows the observer recognizing the 3D image at a position “B” during the first sub-frame of one frame.

Referring to FIG. 6A, when the observer OB1 is placed at the position “A” during the first sub-frame SF1, the directional backlight unit 500 is driven to supply the light to the fourth to sixth control areas UCA4 to UCA6, in which the observer OB1 is placed, since the position “A” is placed in the first area OA. During the first sub-frame SF1, the light is not supplied to the first to third control areas UCA1 to UCA3 and the seventh and eighth areas UCA7 and UCA8.

Then, when the observer OB1 moves to the position “B”, the “B” position is included in the first area OA during the second sub-frame SF2 (refer to FIG. 6B). Accordingly, the directional backlight unit 500 is driven to supply the light to the third to fifth control areas UCA3 to UCA5, in which the observer OB1 is placed, during the second sub-frame SF2. During the second sub-frame SF2, the light is not supplied to the first and second control areas UCA1 and UCA2 and the sixth to eighth control areas UCA6 to UCA8.

As described above, although the observer moves from one place to another, the light supplied to the observer is controlled after the position of the observer is extracted and checked to ensure that the extracted position of the observer allows the observer to recognize the 3D image. Accordingly, the light is supplied to the observer only when the observer is placed in the first area OA in each sub-frame, and therefore the observer may recognize the 3D image while moving from one place to another.

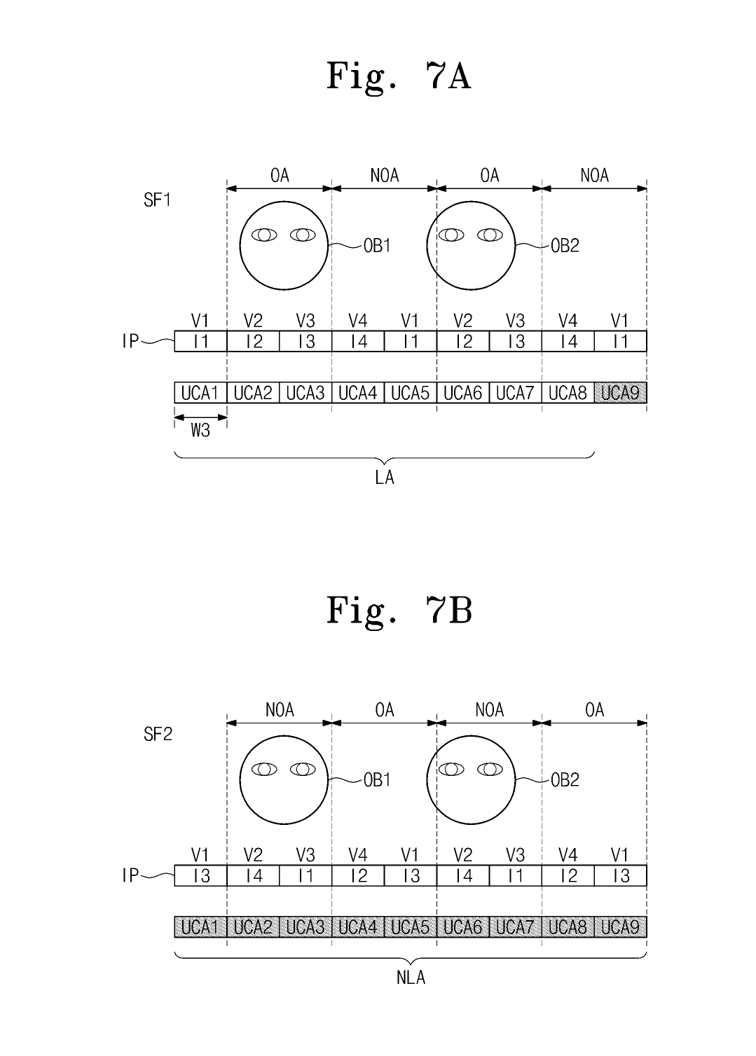

FIGS. 7A and 7B are views describing a method of providing a three-dimensional image when the first and second observers OB1 and OB2 are simultaneously placed in the first area OA or the second area NOA.

Referring to FIG. 7A, the first and second observers OB1 and OB2 are simultaneously placed in the first area OA during the first sub-frame SF1. Accordingly, the directional backlight unit 500 supplies the light to the first and second observers OB1 and OB2 during the first sub-frame SF1.

The image plane IP includes first to ninth control areas UCA1 to UCA9 that are controlled by the unit area UA of the light emitting area control unit 300. Each of the first to ninth control areas UCA1 to UCA9 has a width W3 that is equal to a width of each of the first to fourth viewing zones V1 to V4. As an example, when the width of each of the first to fourth viewing zones V1 to V4 is set to the distance between both eyes of each observer (e.g., about 65 mm), the width W3 of each of the first to ninth control areas UCA1 to UCA9 may be about 65 mm.

In some embodiments, the 3D image display apparatus 1000 may be a four-view display apparatus that provides four views on the image plane IP. In those embodiments, each of the first area OA (which allows the 3D image to be displayed) and the second area NOA (which does not allow the 3D image to be displayed) is arranged so as to correspond to two viewing zones on the image plane IP.

As shown in FIG. 7A, when the first and second observers OB1 and OB2 are respectively placed in two first areas OA adjacent to each other with a second area NOA disposed therebetween, the illumination area LA supplied with the light by the directional backlight unit 500 includes first to eighth control areas UCA1 to UCA8. Here, the first to fourth control areas UCA1 to UCA4 correspond to the illumination area LA for the first observer OB1, and the fifth to eighth control areas UCAS to UCA8 correspond to the illumination area LA for the second observer OB2.

As shown in FIG. 7B, when the image information displayed on the image plane IP is changed during the second sub-frame SF2, the area in which the first and second observers OB1 and OB2 are placed is changed to the second area NOA. Thus, since the first and second observers OB1 and OB2 are placed in an area (which does not allow the first and second observers OB1 and OB2 to recognize the 3D image) during the second sub-frame SF2, the directional backlight unit 500 is controlled such that the first to eighth control areas UCA1 to UCA8 correspond to the non-illumination area NLA in which the first and second observers OB1 and OB2 are placed.

In FIG. 7A, the illumination area LA for each of the first and second observers OB1 and OB2 has a width equal to a width of four viewing zones V1 to V4, but the inventive concept is not limited thereto. In some other embodiments, the illumination area LA may have a width equal to a width of five or six viewing zones.

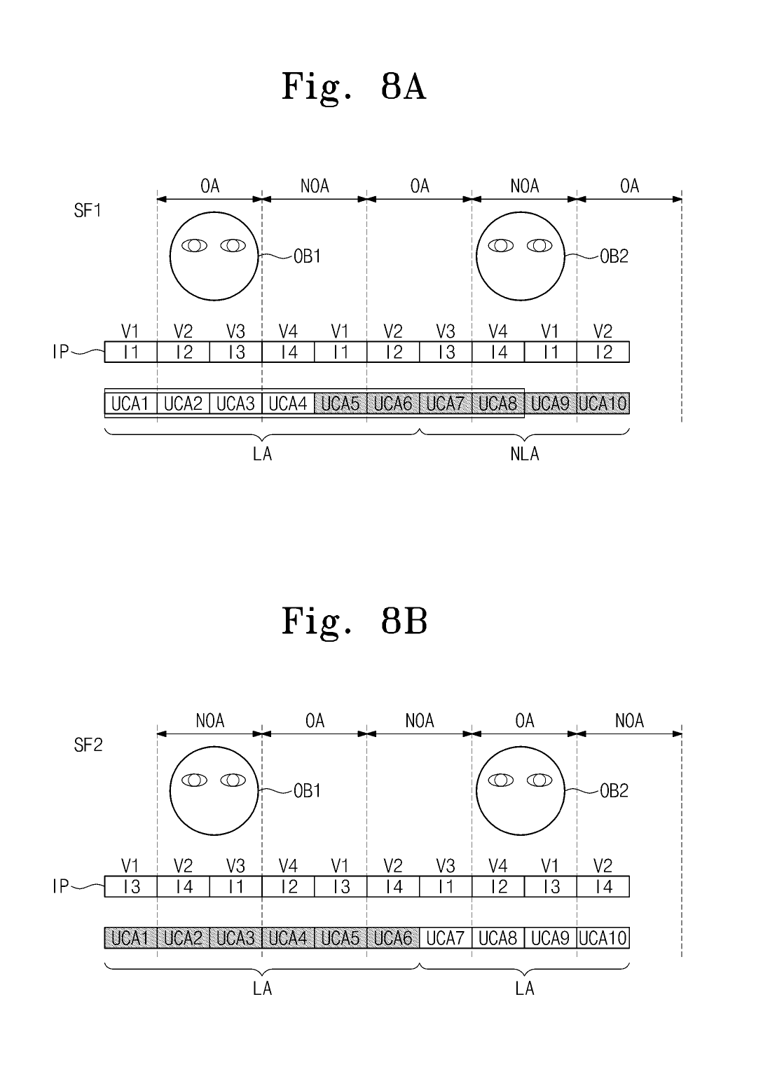

FIGS. 8A and 8B are views describing a method of providing the three-dimensional image when the first and second observers are respectively placed in the first and second areas.

Referring to FIG. 8A, the first observer OB1 is placed in the first area OA and the second observer OB2 is placed in the second area NOA during the first sub-frame SF1. Accordingly, the directional backlight unit 500 supplies the light to the first observer OB1 during the first sub-frame SF1 and does not supply the light to the second observer OB2 during the first sub-frame SF1.

When the first and second observers OB1 and OB2 are spaced apart from each other by a distance corresponding to a width of six viewing zones, the illumination area LA of the directional backlight unit 500 may include first to fourth control areas UCA1 to UCA4. The width of the illumination area LA of the directional backlight unit 500 is greater than at least the width of the first area OA in which the first observer OB1 is placed. In some embodiments, the width of the illumination area LA may be two times greater than the width of the first area OA.

The non-illumination area NLA of the directional backlight unit 500 is disposed covering the second area NOA in which the second observer OB2 is placed. As an example, the non-illumination area NLA of the directional backlight unit 500 may include seventh to tenth control areas UCA7 to UCA10. Fifth and sixth control areas UCA5 and UCA6 disposed between the illumination area LA and the non-illumination area NLA may be included in the illumination area LA or the non-illumination area NLA.

In FIGS. 8A and 8B, the fifth and sixth control areas UCA5 and UCA6 are included in the non-illumination area NLA.

As shown in FIG. 8B, when the image information displayed on the image plane IP is changed, the area in which the first observer OB1 is placed is changed to the second area NOA and the area in which the second observer OB2 is placed is changed to the first area OA. Therefore, since the first observer OB1 is placed in an area (which does not allow the first observer OB1 to recognize the 3D image) during the second sub-frame SF2, the directional backlight unit 500 is controlled such that the first to fourth control areas UCA1 to UCA4, in which the first observer OB1 is placed, are driven as the non-illumination area NLA.

The illumination area LA of the directional backlight unit 500 may include the seventh to tenth control areas UCA7 to UCA10 in which the second observer OB2 is placed.

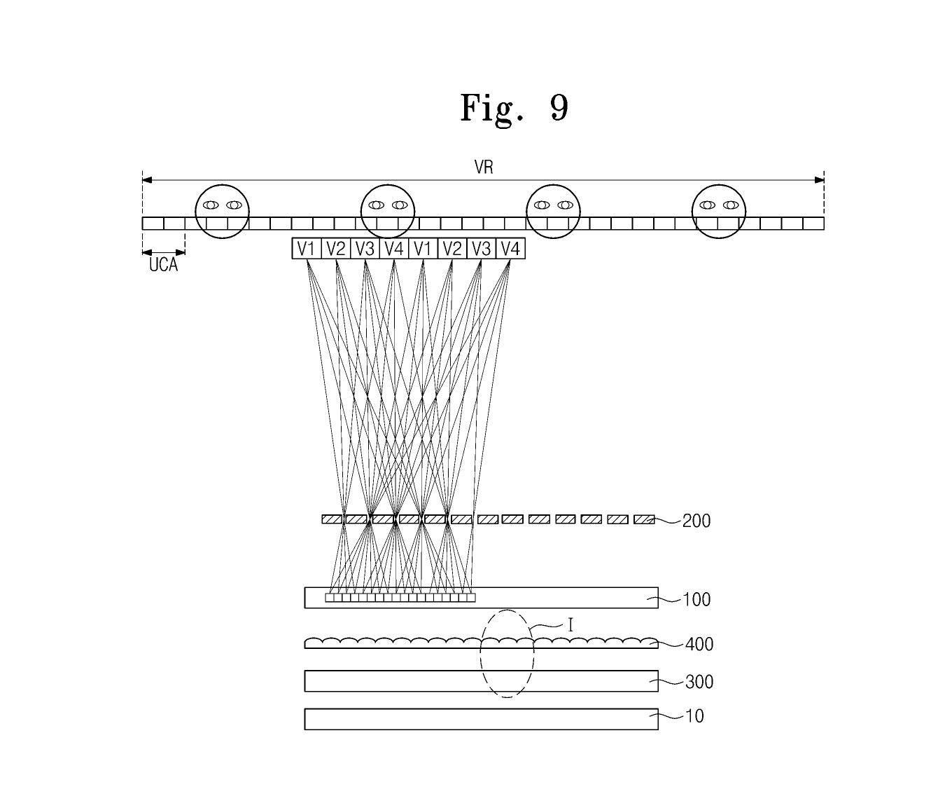

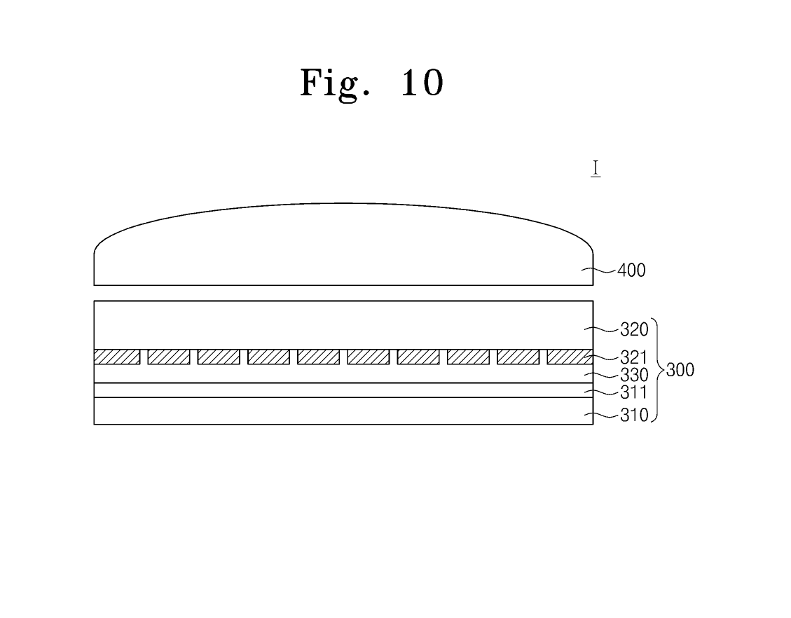

FIG. 9 is a view showing a visible range of the three-dimensional image display apparatus and FIG. 10 is a partially enlarged view showing the portion “I” in FIG. 9.

Referring to FIGS. 9 and 10, the image plane IP includes a plurality of control areas UCA that are controlled by the unit area UA (refer to FIGS. 2A and 2B) of the light emitting area control unit 300.

Here, when each control area UCA has a width of about 130 mm and the visible range VR is set to about 2080 mm on the image plane IP, sixteen control areas are included in the visible range VR. To control the supply and blockage of the light to the sixteen control areas, the light emitting area control unit 300 is required to include at least sixteen control electrodes in one unit area UA. That is, a value obtained by multiplying the number of the control electrodes disposed in one unit area UA by the width W1 of each control area UCA may be set to the visible range VR.

As shown in FIG. 10, the light emitting area control unit 300 includes a first substrate 310, a second substrate 320, and a liquid crystal layer 330 interposed between the first substrate 310 and the second substrate 320. The first substrate 310 includes a reference electrode 311 which is integrally formed as a single unitary and individual unit. The second substrate 320 includes a plurality of control electrodes 321 that are used to control the twisting degree of liquid crystal molecules of the liquid crystal layer 330 using the intensity of an electric field formed between the reference electrode 311 and the control electrodes 321. The unit area UA corresponds to one lens of the directional control unit 400 and the sixteen control electrodes 321 may be arranged in the unit area UA in the present exemplary embodiment.

However, it should be noted that the number of the control units 321 need not be limited to sixteen. That is, the number of the control electrodes 321 may vary depending on the width W1 of the control area and the visible range VR.

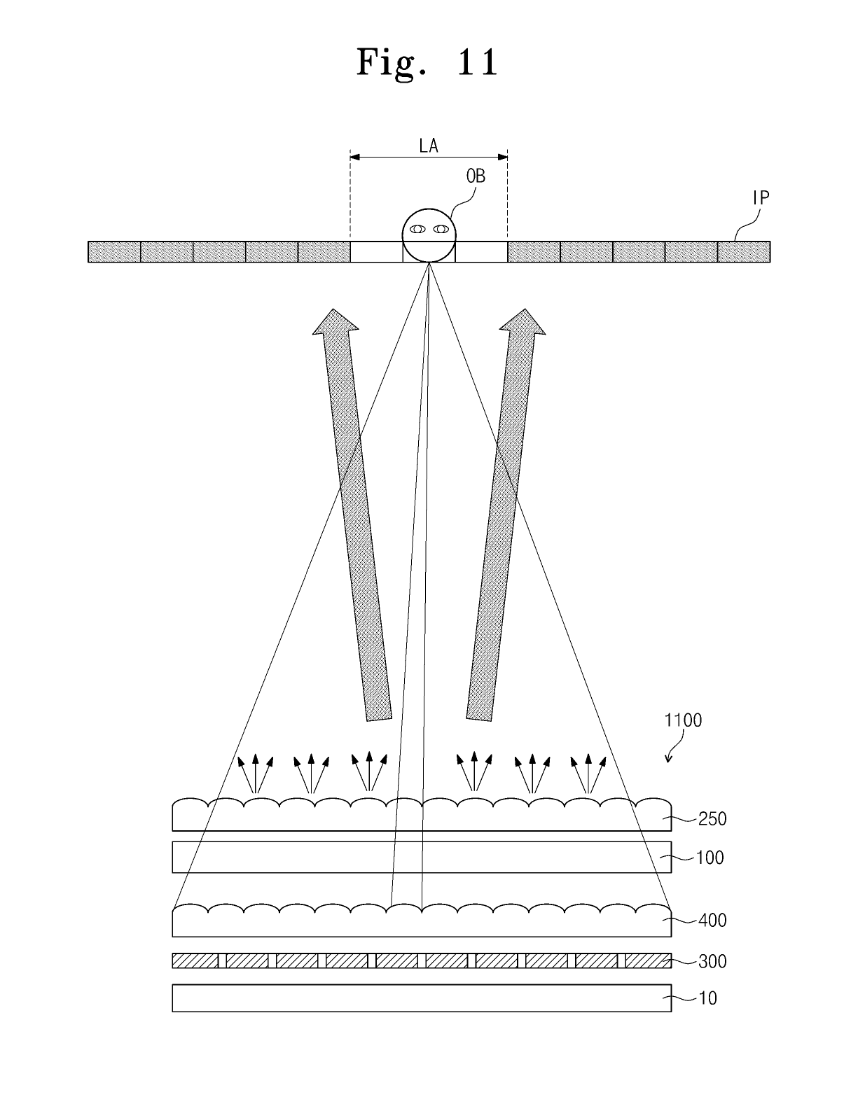

FIG. 11 is a cross-sectional view showing a three-dimensional image display apparatus 1100 according to another exemplary embodiment of the present disclosure. In FIG. 11, the same reference numerals denote the same elements in FIG. 9, and thus a detailed description of the same elements will be omitted.

Referring to FIG. 11, the 3D image display apparatus 1100 has substantially the same structure and function as the 3D image display apparatus 1000 shown in FIG. 1, except that the viewpoint generating unit 200 in FIG. 11 includes a liquid crystal lens panel 250 instead of a liquid crystal barrier panel.

The liquid crystal lens panel 250 is disposed between the observer OB and the display unit 100, and driven in response to an applied voltage so as to provide a lens function. When no voltage is applied to the liquid crystal lens panel 250, the liquid crystal lens panel 250 transmits the 2D image from the display unit 100, so that the 3D image display apparatus 1100 is operated in the 2D mode. When the voltage is applied to the liquid crystal lens panel 250, the liquid crystal lens panel 250 converts the 2D image from the display unit 100 to the 3D image, and thus the 3D image display apparatus 1100 is operated in the 3D mode.

In addition, the liquid crystal lens panel 250 is in synchronization with the time division mode of the display unit 100, so as to shift a profile on the lens surface by a predetermined pitch at every sub-frame.

During the 3D mode, a liquid crystal lens having the same pitch as the view set is formed on the liquid crystal lens panel 250, and a difference in phase of the light emitted from the display unit 100 is generated in accordance with the position of the liquid crystal lens. Therefore, the liquid crystal lens panel 250 may control the path of the light from the display unit 100. Due to the phase difference, the binocular disparity is generated between the images provided to the left and right eyes of the observer, and thus the observer may recognize the 3D image.

As shown in FIG. 11, the directional backlight unit 500 is controlled to allow the illumination area LA having a first width to be formed on the image plane IP. However, the first width of the illumination area LA may increase since the light from the directional backlight unit 500 is refracted while passing through the liquid crystal lens. Accordingly, the width of the illumination area LA controlled by the directional backlight unit 500 may be increased.

Accordingly, when the liquid crystal lens panel 250 is used, the illumination area LA may be more precisely controlled than when the liquid crystal barrier panel 200 is used, since the number of the control areas in the visible range VR is increased (when using the liquid crystal lens panel 250).

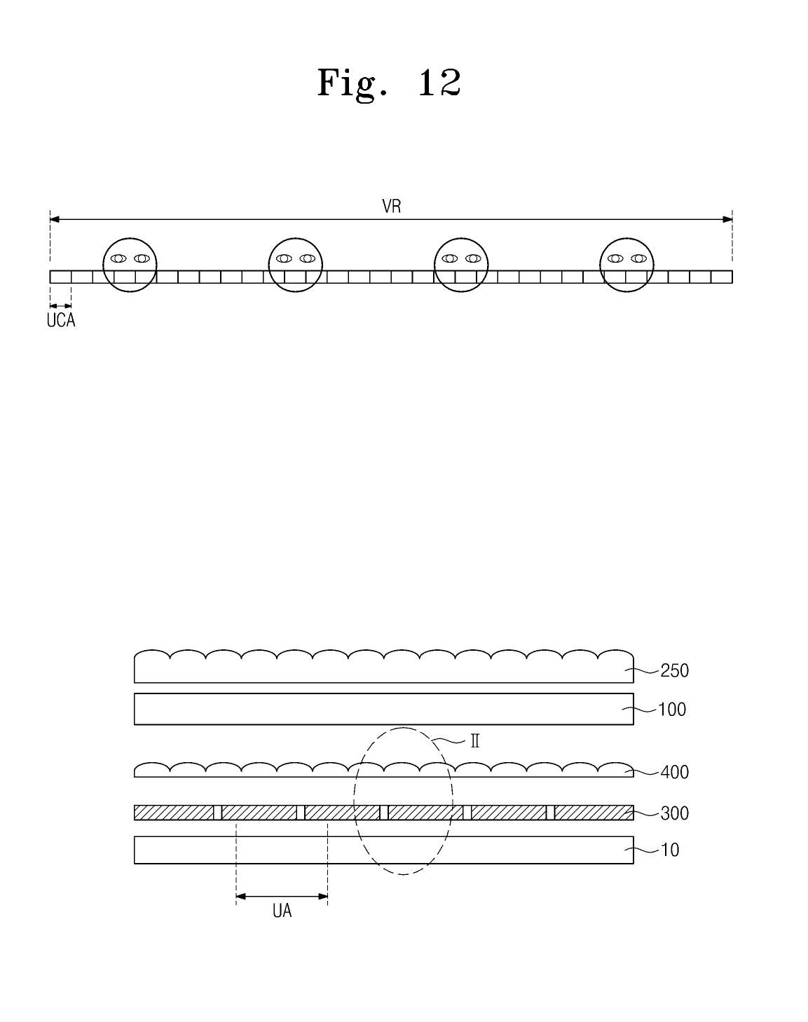

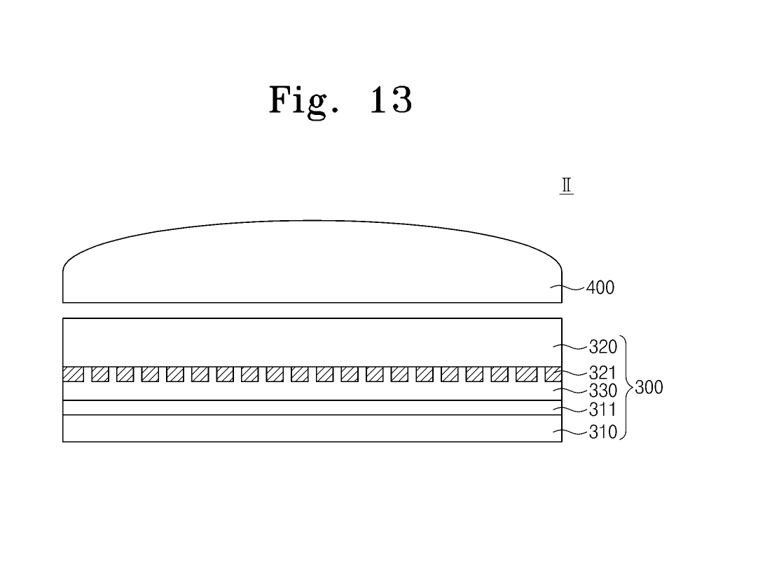

FIG. 12 is a view showing a visible range of the three-dimensional image display apparatus in FIG. 11, and FIG. 13 is a partially enlarged view showing the portion “II” in FIG. 12.

Referring to FIGS. 12 and 13, the image plane IP includes a plurality of control areas UCA that are controlled by the unit area UA of the light emitting area control unit 300.

Here, when each control area UCA has a width of about 65 mm and the visible range VR is set to about 2080 mm on the image plane IP, thirty-two control areas are included in the visible range VR. To control the supply and blockage of the light to the thirty-two control areas, the light emitting area control unit 300 is required to include at least thirty-two control electrodes in one unit area UA.

As shown in FIG. 13, the light emitting area control unit 300 includes a first substrate 310, a second substrate 320, and a liquid crystal layer 330 interposed between the first substrate 310 and the second substrate 320. The first substrate 310 includes a reference electrode 311 which is integrally formed as a single unitary and individual unit. The second substrate 320 includes a plurality of control electrodes 321 that are used to control the twisting degree of liquid crystal molecules of the liquid crystal layer 330 using the intensity of an electric field formed between the reference electrode 311 and the control electrodes 321. The unit area UA corresponds to one lens of the directional control unit 400 and the thirty-two control electrodes 321 may be arranged in the unit area UA in the present exemplary embodiment.

However, it should be noted that the number of the control units 321 need not be limited to thirty-two. That is, the number of the control units 321 may vary in other embodiments.

Although different exemplary embodiments of the inventive concept have been described, it is understood that the inventive concept is not limited to those exemplary embodiments, and that various changes and modifications to the embodiments can be made by one of ordinary skill in the art within the spirit and scope of the present disclosure.

What is claimed is:

1. An image display apparatus comprising:
a display unit configured to display an image;
a viewpoint generating unit configured to operate in a 2D mode or a 3D mode so as to render the image as a 2D image or a 3D image, and to generate N viewpoints in different directions while operating in the 3D mode; and
a directional backlight unit configured to supply light to an illumination area of an image plane, wherein the image plane is placed at a visible distance to a plurality of observers and the image from the display unit is projected onto the image plane, and
wherein positions of the illumination area and a non-illumination area of the image plane are changed based on positional information of the plurality of observers.

2. The image display apparatus of claim 1, wherein images of the N viewpoints are displayed in a plurality of view sets disposed on the image plane, and wherein the illumination area has a width equal to or greater than a width of each of the view sets.

3. The image display apparatus of claim 2, wherein each of the view sets comprises N viewing zones, each of the illumination area and the non-illumination area comprises a plurality of control areas, and each of the control areas has a width equal to or greater than a width of the viewing zones.

4. The image display apparatus of claim 3, wherein the width of each of the control areas corresponds to two times the width of the viewing zones.

5. The image display apparatus of claim 3, wherein the width of each of the viewing zones corresponds to a distance between both eyes of each observer.

6. The image display apparatus of claim 1, wherein the directional backlight unit further comprises:
a backlight configured to generate the light;
a light emitting area control unit disposed between the display unit and the backlight, wherein the light emitting area control unit includes a slit part to transmit the light and a barrier part to block the light when the viewpoint generating unit is operating in the 3D mode, and wherein positions of the slit part and the barrier part are changed in accordance with the positional information of the observers; and
a directional control unit configured to guide the light being transmitted through the slit part to the illumination area.

7. The image display apparatus of claim 6, wherein the light emitting area control unit further comprises:
a first substrate including a reference electrode;
a second substrate facing the first substrate and including a plurality of control electrodes disposed in a unit area; and
a liquid crystal layer interposed between the first substrate and the second substrate, and wherein the position and width of the illumination area are changed in accordance with a position and number of the control electrodes that are applied with a driving voltage.

8. The image display apparatus of claim 7, wherein, when “m” number of the control electrodes are disposed in the unit area and each of the illumination area and the non-illumination area comprises a plurality of control areas, a width of a visible range is obtained by multiplying a width of each of the control areas by “m”.

9. The image display apparatus of claim 7, wherein the display unit is configured to drive one frame in a time division mode after dividing the one frame into at least two sub-frames, and the light emitting area control unit is driven such that the positions of the illumination area and the non-illumination area are changed in a unit of the sub-frame.

10. The image display apparatus of claim 7, wherein the directional control unit includes a lens film including a plurality of lenticular lenses.

11. The image display apparatus of claim 10, wherein each of the lenticular lenses has a width corresponding to the unit area.

12. The image display apparatus of claim 1, further comprising:
a position information extracting unit configured to extract the positional information of the observers; and
a control unit configured to control a drive of the directional backlight unit in accordance with the positional information.

13. The image display apparatus of claim 12, wherein the image plane comprises a first area that allows the observers to recognize the 3D image and a second area that does not allow the observers to recognize the 3D image, and positions of the first and second areas are changed by the time division drive of the display unit and the viewpoint generating unit.

14. The image display apparatus of claim 13, wherein the control unit is configured to check whether each of the observers is placed in the first area or in the second area in accordance with the positional information, and to drive the directional backlight unit in the time division mode in synchronization with the display unit to control the position of the illumination area such that the observer placed in the first area receives the light in each sub-frame.

15. The image display apparatus of claim 1, wherein the viewpoint generating unit comprises a liquid crystal barrier panel in which a transmission area transmitting the light and a blocking area blocking the light are alternately arranged with each other in a first direction so as to connect the left and right eyes of the observer.

16. The image display apparatus of claim 1, wherein the viewpoint generating unit comprises a liquid crystal lens panel arranged in a first direction so as to connect the left and right eyes of the observer, and wherein the viewpoint generating unit extends in a second direction substantially perpendicular to the first direction.

17. A method of driving an image display apparatus, comprising:
forming N viewpoints in different directions when a display unit, which is configured to operate in a 2D mode or a 3D mode so as to render an image displayed on the display unit as a 2D image or a 3D image, is being operated in the 3D mode;
extracting positional information of a plurality of observers with reference to the display unit;
dividing an image plane placed at a visible distance to the plurality of observers into a first area that allows the observers to recognize the 3D image and a second area that does not allow the observers to recognize the 3D image, wherein the image from the display unit is projected onto the image plane;
changing positions of the first and second areas through a time division drive; and
controlling, in accordance with the position information, an illumination area and a non-illumination area formed on the image plane.

18. The method of claim 17, wherein images of the N viewpoints are displayed in a plurality of view sets disposed on the image plane, and the illumination area has a width equal to or greater than a width of each of the view sets.

19. The method of claim 18, wherein each of the view sets comprises N viewing zones, each of the illumination area and the non-illumination area comprises a plurality of control areas, and each of the control areas has a width equal to or greater than a width of the viewing zones.

20. The method of claim 19, wherein the width of each of the control areas corresponds to two times the width of the viewing zones, and the width of each of the viewing zones corresponds to a distance between both eyes of each observer.
